(19) United States
(12) Patent Application Publication
(10) Pub. No.: US 2021/0035110 A1
(43) Pub. Date: Feb. 4, 2021

(54) BLOCKCHAIN TRANSACTION FUZZY VALIDATION

(71) Applicants: Kelsey L. Bruso, Eagan, MN (US); Kevin Flanders, Eagan, MN (US)

(72) Inventors: Kelsey L. Bruso, Eagan, MN (US); Kevin Flanders, Eagan, MN (US)

(73) Assignee: Unisys Corporation, Blue Bell, PA (US)

(21) Appl. No.: 16/529,888

(22) Filed: Aug. 2, 2019

(51) Int. Cl. G06Q 20/40; G06Q 20/36; H04L 9/06; G06Q 20/38

(52) U.S. Cl. CPC G06Q 20/40145; G06Q 20/3829; H04L 9/0637; G06Q 20/3674

(57) ABSTRACT

A computing system architecture includes a service server and a first validator. The first validator is communicable to the service server. A validation request is sent from the service server to the first validator for validating a transaction. The validation request including a first facial image of a party of the transaction. The validator performs a facial recognition comparing the first facial image with a second facial image using a facial recognition algorithm.

### FIELD OF THE DISCLOSURE

The present invention relates to blockchain transaction fuzzy validation. More specifically, the present invention relates to computational architectures, apparatuses, and methods for validating a transaction in a blockchain using a fuzzy logic approach such as facial recognition.

### BACKGROUND

Blockchain is a concept of validating and recording an individual or a chain of transactions in a decentralized computing architecture. When a transaction happens, one or more validators would validate the transaction for possible inclusion into the distributed ledger which represents the blockchain. Once validated, a transaction ledger entry, also known as a block, is created and integrated into the existing chain of transactions, e.g., a chain of ownership changes of a good or a piece of digitized currency. A large number of repetitive copies of the transaction ledger is stored on different computers over the internet, e.g., end user computers, servers, etc. This practice of storing large number of repetitive copies of ledgers denotes the concept of decentralization, of which some consider important to a blockchain system.

Blockchain represents an ordered set of transactions that have been validated or confirmed within the system up to a certain point in time. For security purposes, the blockchain is supposed to include only valid transactions and, as far as these transactions are included in the ledger, it should be impossible for someone to alter or remove the recorded ledger entry from the blockchain. Most cryptocurrencies implement a distributed ledger, comprised of the peers in the network, i.e., by having the network peers decide which transaction should be validated by means of a consensus protocol.

One of the main benefits of a decentralized ledger is that it can be public, and the transactions in it publicly verifiable. That is, every user of the system may be able to obtain a copy of the ledger, and his/her transactions, verify that the list of transactions in the ledger are valid, and verify the correctness of the ledger itself, for example, by confirming that the entity that extends the ledger by adding more transactions to it confirms only valid transactions.

A major technical issue exists in the current blockchain system. The validation process is not sufficiently flexible. The current validation algorithms are tailored to ask simple yes/no questions. The validators can be parties of the transaction-in-interest or an independent third party. Examples of current validation algorithms inquire “does the sender have more than X amount of digitized currencies in his wallet?” or “Does the seller of this Gucci handbag have provenance of ownership?” or “Did the shipper of this pallet of fruit complete all required paper works?” These simple yes/no questions or records are relatively easy to validate. The embodiments disclosed herein provide alternative validation methods that are much more flexible compared to current methods.

### SUMMARY

The present invention relates to blockchain transaction fuzzy validation. More specifically, the present invention relates to computational architectures, apparatuses, and methods for validating a transaction in a blockchain using a fuzzy logic approach such as for facial recognition. The present invention describes three technical issues for the solution to the described blockchain inadequacies: first, how fuzzy algorithms work and where they are used; second, the mechanism for identifying the fuzzy algorithm for the transaction validators to use when validating a transaction; and third, the mechanism for identifying the threshold value to be used by the validators.

In some embodiments of the disclosure, creating a blockchain involves using a public/private key pair for securing information in a transaction in a block and for proving the identity of each party to a transaction. To enter a new transaction into a blockchain system, the parties who participate in the transaction each encrypt a portion of the transaction using their private key. The private key encrypted portion of the transaction can be decrypted using the party's public key.

In one embodiment, a previous transaction was done between party A and party B, wherein party A was the seller and party B was the buyer of an item. A first portion of the previous transaction was encrypted with party A's private key. A second portion of the previous transaction was encrypted with party B's private key. The second portion of the previous transaction may be a facial image and/or a finger print image of the party B. Subsequently, party B is conducting a current transaction to sell the item to party C. In the current transaction, party C needs to verify the ownership of the item which involves facial and/or fingerprint recognition. The second portion of the previous transaction which includes the facial and/or finger print images of party B may be decrypted with party B's public key.

The embodiments disclosed herein aim to resolve the technical issues of current blockchain system. Regarding the first technical issue, current validation algorithms are tailored to ask simple yes/no questions. The validators can be parties of the transaction at issue or an independent third party. Examples of current validation algorithms inquire “does the sender have more than X amount of digitized currencies in his wallet?” or “Does the seller of this Gucci handbag have provenance of ownership?” or “Did the shipper of this pallet of fruit complete all required paper works?” In contrast, fuzzy logic estimates and returns a probability of truth for a question.

Facial recognition algorithms use a set of criteria to describe a person's face. An example algorithm uses a set of 100 criteria to describe a face. When comparing two facial images, each facial image is described using 100 criteria, if 80 of the criteria match and 20 of the criteria do not match, the comparison reports a confidence score of 80% that the facial images match. Different algorithms use more or fewer criteria with different results. Some authorization systems use facial recognition as a biometric identifier either alone or in conjunction with other proofs of identity such as a password for a multi-factor authentication approach. Other authorization systems use fingerprint images as a biometric identifier. Similar to facial recognition, fingerprint recognition algorithms use a set of criteria to describe a person's fingerprint. Fingerprint comparison processing likewise returns a confidence score that two fingerprints match. Incorporating a fuzzy logic capability such as facial recognition into the blockchain transaction validation mechanism makes the blockchain technique applicable to a wider set of transaction types. Requiring validation of facial features of one or more parties of a transaction or requiring validation of fingerprint features of one or more parties of a transaction makes the transaction more secure comparing to simply knowing the party's public key.

Regarding the second technical issue, embodiments disclosed herein introduce fuzzy logic algorithms into the validation process. The facial features of a person are relatively stable over time. Facial features used in the embodiments herein for facial recognition includes eye color, eye sizes, retina pattern, distance between eyes, lip shape/size, nose shape/size, cheek shape, etc. The time frame of a facial feature of a person to change is much longer than the frequency of conducting transactions by that person. Some algorithms attribute more or less importance to each of the criteria by assigning each criterion a weighting factor—the higher the weighting factor the more impact that criterion has on determining the confidence score. Each algorithm uses a different set of criteria and different weightings for each criterion.

In one embodiment, the fuzzy algorithm performs facial recognition. In another embodiment, the fuzzy algorithm performs fingerprint recognition. Additional embodiments use other fuzzy algorithms for other purposes. The fuzzy algorithm is used for transaction validation purpose.

Regarding the location or indicia for finding the fuzzy algorithm, one embodiment encodes the algorithm or other indicia for the algorithm in the genesis block of the blockchain. The genesis block describes the nature of the blockchain and rules for participating in the blockchain. A second embodiment encodes the algorithm or an indicia for the algorithm in a smart contract of the blockchain. A third embodiment encodes the algorithm in the validators.

Regarding the third technical issue, embodiments disclosed herein introduce fuzzy logic threshold value processing into the validation process. In one embodiment, it allows the blockchain system to set a threshold value for the fuzzy logic probability score, above which the transaction is considered valid. In a second embodiment, each validator returns the fuzzy logic probability score itself rather than comparing the probability against a threshold value and returning a pass or fail indicator.

Regarding the location or indicia for finding the threshold value, one embodiment encodes the threshold value or other indicia for the threshold value in the genesis block of the blockchain. The genesis block describes the nature of the blockchain and rules for participating in the blockchain. A second embodiment encodes the threshold value or other indicia for the threshold value in a smart contract of the blockchain. A third embodiment encodes the threshold value or other indicia for the threshold value in the transaction itself, passed by the parties of the transaction.

The foregoing has outlined rather broadly the features and technical advantages of the present invention in order that the detailed description of the invention that follows may be better understood. Additional features and advantages of the invention will be described hereinafter that form the subject of the claims of the invention. It should be appreciated by those skilled in the art that the concepts and specific embodiments disclosed may be readily utilized as a basis for modifying or designing other structures for carrying out the same purposes of the present invention. It should also be realized by those skilled in the art that such equivalent constructions do not depart from the spirit and scope of the invention as set forth in the appended claims. The novel features that are believed to be characteristic of the invention, both as to its organization and method of operation, together with further objects and advantages will be better understood from the following description when considered in connection with the accompanying figures. It is to be expressly understood, however, that each of the figures is provided for the purpose of illustration and description only and is not intended as a definition of the limits of the present invention.

### BRIEF DESCRIPTION OF THE DRAWINGS

For a more complete understanding of the disclosed systems and methods, reference is now made to the following descriptions taken in conjunction with the accompanying drawings.

FIG. 1 is a diagram of blockchain system communication architecture according to one embodiment of the disclosure.

FIG. 2 is a method of transaction validation for a member service server according to one embodiment of the disclosure.

FIG. 3 is a method of transaction validation for a validator according to one embodiment of the disclosure.

FIG. 4 illustrates a computer network for obtaining access to database files in a computing system according to one embodiment of the disclosure.

FIG. 5 illustrates a computer system adapted according to certain embodiments of the processor and/or the user interface device.

### DETAILED DESCRIPTION

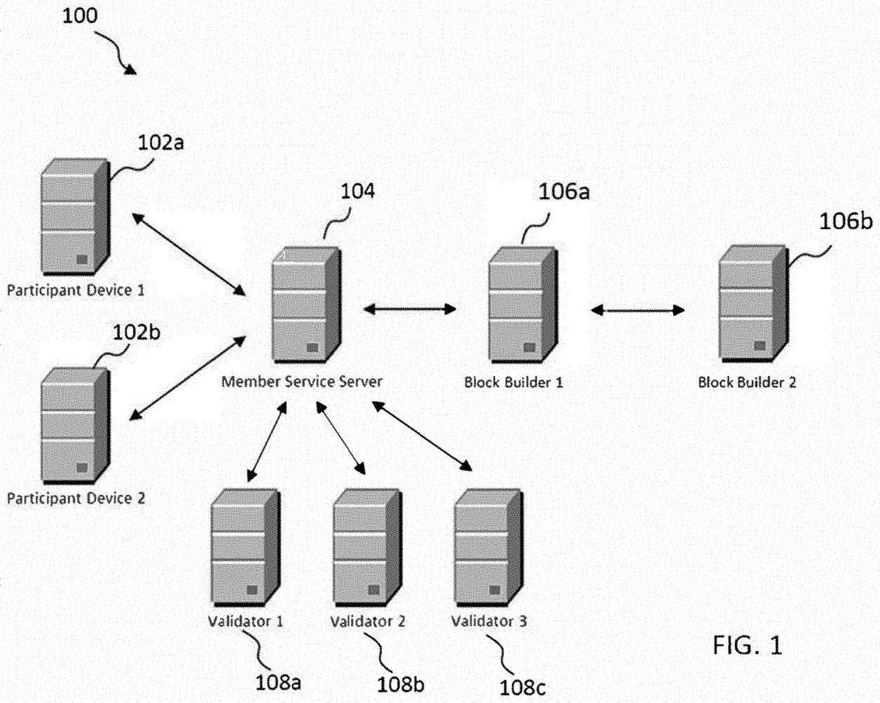

FIG. 1 is a diagram of blockchain system communication architecture 100 according to one embodiment of the disclosure. The architecture includes a plurality of participant devices 102a, 102b. The participant devices 102a, 102b can be the buyer or seller of goods or services. In one embodiment, the first participant device 102a is a seller in a transaction and the second participant device 102b is a buyer in the same transaction.

The member service server 104 receives transaction requests from the participant devices 102a, 102b. In one embodiment, the member service server 104 is a platform for conducting the transaction. In another embodiment, member service server is a validator, elected to oversee the validation for the transaction submitted by participant device 102a, 102b. The member service server 104 receives a record validation request from a participant device 102a, 102b. The request can include information about the transaction, e.g., the identity of a party of the transaction, the facial image of the party, the serial number of the participant device 102, the remaining balance of the electronic wallet of the party, the ownership of goods/services associated with the party, or the like. Some information in the transaction is encrypted using the private key of a party of the transaction. In one embodiment, the facial image of the party is encrypted using the party's private key.

The member service server 104 distributes the validation request to a plurality of validators 108a, 108b, 108c.

Each of the validators 108a, 108b, 108c conduct one or more independent examinations of the information included in the request for validating the transaction. The validation mechanism may include a fuzzy logic algorithm according to this disclosure. In one embodiment, the algorithm processes facial images.

The member service server 104 receives a pass/fail signal from each of the validators 108a, 108b, 108c. The validators 108a, 108b, 108c determine whether the information included in the request being sufficient and valid for validating the particular transaction. A “pass” signal means the record validation request includes information sufficient for validating an associated transaction. A “fail” means the record validation request does not include sufficient information for validating the associated transaction.

The member service server 104 determines whether a threshold percentage of the validators 108a, 108b, 108c provide a “pass” signal. If the threshold percentage is met, the member service server 104 will validate the transaction. If the threshold percentage is not met, the member service server 104 will terminate the transaction. In one embodiment, the threshold percentage is 51%, that is, 51% of the validators must provide a “pass” signal.

If the transaction is validated, the member service server 104 broadcasts the validated transaction to a plurality of block builders 106a, 106b for inclusion into the next block of the blockchain. In one embodiment, the set of block builder 106 are different from the set of validator 108. In another embodiment, each block builder 106 may also play the role of validator 108.

The new block will be annexed to the blockchain. In one embodiment, the new block includes the identity of the new owner of the goods/services transacted and the facial image of the new owner. The facial image is stored in the blockchain such that a subsequent transaction can use the stored facial image for further processing.

In some embodiments of the disclosure, creating a blockchain involves using a public/private key pair for securing information in a transaction in a block and for proving the identity of each party to a transaction. To enter a new transaction into a blockchain system, the parties who participate in the transaction each encrypt a portion of the transaction using their private key. The private key encrypted portion of the transaction can be decrypted using the party's public key.

In one embodiment, a previous transaction was done between party A and party B, wherein party A was the seller and party B was the buyer of an item. A first portion of the previous transaction was encrypted with party A's private key. A second portion of the previous transaction was encrypted with party B's private key. The second portion of the previous transaction may be a facial image and/or a finger print image of the party B. Subsequently, party B is conducting a current transaction to sell the item to party C. In the current transaction, party C needs to verify the ownership of the item which involves facial and/or finger print recognitions. The second portion of the previous transaction which includes the facial and/or finger print images of party B may be decrypted with party B's public key.

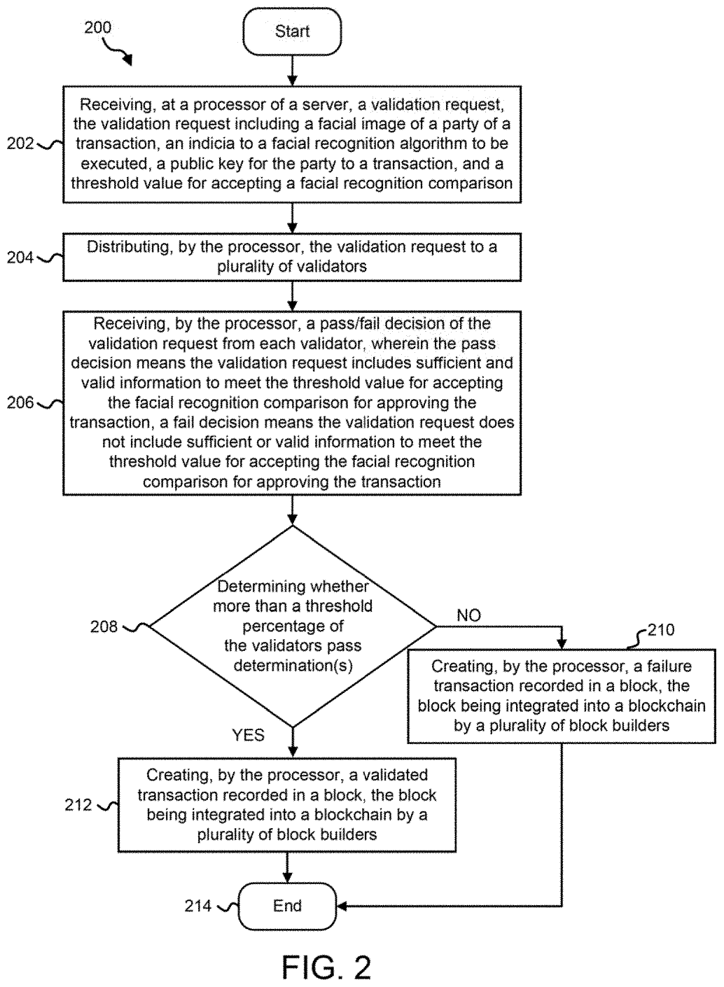

FIG. 2 is a method 200 of transaction validation for a member service server according to one embodiment of the disclosure. The method 200 can be used by the member service server 104.

The method 200 includes 202 receiving, at a processor of a server, a validation request. The validation request includes a facial image of a party of a transaction. The validation request, a blockchain genesis block, a smart contract, or the like may include indicia for requiring a fuzzy algorithm for validating the transaction. In one embodiment, the fuzzy algorithm is a facial recognition algorithm as in 202. In another embodiment, the fuzzy algorithm is a finger print recognition algorithm.

In one embodiment, the transaction validation request includes a public key of the party of the transaction. This public key can be used to decrypt a facial image of the party previously stored. Or, the public key can be used to encrypt a facial image currently provided.

In one embodiment, the transaction validation request includes a threshold value for accepting a facial recognition comparison. Facial recognition algorithms use a set of criteria to describe a person's face. An example algorithm uses a set of 100 criteria to describe a face. When comparing two facial images, each facial image is described using 100 criteria, if 80 of the criteria match and 20 of the criteria do not match, the comparison reports a confidence score of 80% that the facial images match. In one embodiment, 80% may be the threshold value at 202. Different algorithms use more or fewer criteria with different results. Some authorization systems use facial recognition as a biometric identifier either alone or in conjunction with other proofs of identity such as a password for a multi-factor authentication approach. Other authorization systems use fingerprint images as a biometric identifier. Similar to facial recognition, fingerprint recognition algorithms use a set of criteria to describe a person's fingerprint. Fingerprint comparison processing likewise returns a confidence score that two fingerprints match.

In other embodiments, the validation request at 202 can include the following information about the transaction, e.g., the identity of a party of the transaction, the facial image of the party, the serial number of the participant device, the remaining balance of the electronic wallet of the party, the ownership of goods/services associated with the party, or the like.

The method includes 204 distributing, by the processor, the validation request to a plurality of validators (e.g., 108a, 108b, 108c). At 204, each of the validators may conduct one or more independent examinations of the information included in the validation request for validating the transaction. The blockchain genesis block, smart contract, or other indicia indicates one method for facial recognition from among the various available methods. Various validation method at 204 may include different facial recognition algorithms. Different facial recognition algorithms may examine different facial features, e.g., skin tone, hair color, eyebrow color, eye color, eye sizes, retina pattern, distance between eyes, lip shape/size, nose shape/size, cheek shape, etc. In one embodiment, different facial recognition algorithms may give different weights to different facial features. For example, one facial recognition algorithm can be generally expressed as Q=w₁f₁+w₂f₂+w₃f₃+ . . . wₙfₙ, wherein Q is a final score; w is a weight factor for the corresponding facial feature; f is the facial feature; n is any positive integer representing numbers of facial features considered in the algorithm. In one embodiment, the various wᵢ are coefficients, wherein the summations of wᵢ is 1, which can be expressed as 1=Σᵢ₌₁ⁿwᵢ. In some embodiments, different facial recognition algorithms may have different combination of facial features and weight factors. In one embodiment, the genesis block of the blockchain requires a threshold value θ for Q. When threshold value θ is required by the genesis block, all transactions in the blockchain must meet the threshold θ to be validated. In another embodiment, the smart contract includes the threshold value θ for Q. When it is the smart contract, not the genesis block, requires the threshold value θ, it is specific to the particular transaction (not the entire blockchain). A third embodiment includes the threshold value or other indicia for the threshold value θ for Q in the transaction itself, passed by the parties of the transaction. In one embodiment, if Q>θ or Q=θ, then the determination is “pass;” if Q<θ, then the determination is “fail.”

In another embodiment, the facial recognition algorithm at 204 includes digital alteration recognition, e.g., Photoshop altered images. In one embodiment, the digital alteration recognition recognizes the facial features being digitally altered and restores the altered image to its original form. In one embodiment, if the facial image is determined to be digitally altered, the method 200 automatically fails the transaction.

The method 200 includes 206 receiving, by the processor, a pass/fail decision of the validation request from each validator, wherein the pass decision means the validation request includes sufficient and valid information for approving the transaction, a fail decision means the validation request does not include sufficient or valid information for approving the transaction. One reason for receiving a “fail” decision is that the facial image criteria presented in the transaction fails to match with the facial image criteria of a previously stored facial image. Another reason for receiving a “fail” decision is that the match confidence score (Q) is less than the threshold value (θ) for approving the transaction.

The method 200 includes 208 determining whether more than a threshold percentage of the validators provide “pass” determination(s). If the threshold percentage is met, the method 200 will validate the transaction and move to 212. If the threshold percentage is not met, the method 200 moves to 210. In one embodiment, the method 200 inserts a record of the failed transaction and of its failure into the blockchain at 210. A second embodiment ignores the failed transaction and simply terminates processing at 214.

At 212, the method 200 creates a validated transaction to the block builders 106 to include into a next block in the blockchain. The block created is integrated into an associated blockchain at 212. In one embodiment, the block includes the identity of the new owner of the goods/services transacted and the facial image of the new owner. The facial image is stored in the block created such that a subsequent transaction can use the stored facial image for further processing, e.g., validation or audit.

The method 200 at 212 may employ any blockchain mechanism for building blocks from approved transactions. One embodiment uses “proof of work” when creating a block. Another embodiment uses “proof of stake” when creating a block. The mechanism used is independent of the present disclosure. In one embodiment the block builders 106 are different from the validators 108. In another embodiment, the validators 108 may also play the role of block builder 106.

At 210, the method 200 creates a failure transaction recorded in a block. In 210, similar to 212, the block will be integrated into a blockchain by a plurality of block builders 106. In one embodiment, the block includes the identity and/or the facial image of the party who failed the transaction. The facial image of the failed party is stored in the block created such that a subsequent transaction can use the stored facial image for further processing, e.g., issuing a warning to the other party when this failed party attempted a subsequent transaction, etc.

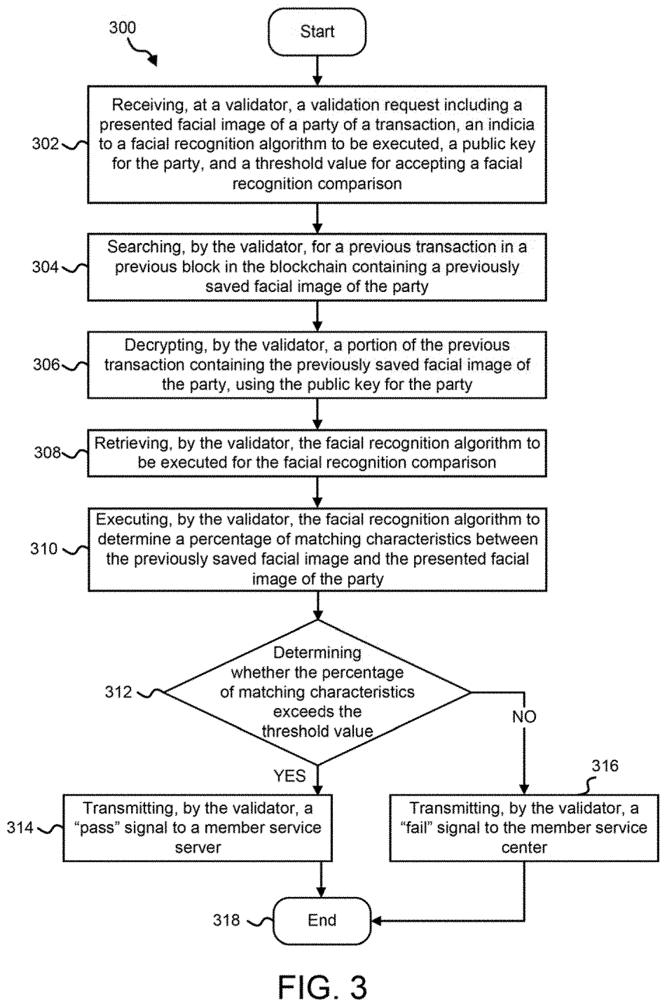

FIG. 3 is a method 300 of transaction validation for a validator 108a, 108b, 180c according to one embodiment of the disclosure. The method 300 includes 302 receiving, at a processor of a validator, from a service server 104 a validation request including a presented facial image (e.g., a first image) of a requestor. This first facial image is the most recent image presented for the transaction. In one embodiment, the method 300 may require the requestor to take the first facial image at the time the transaction is requested, e.g., asking the requestor to face the camera and take a picture. In one embodiment, also receiving at 302 an indicia to the facial recognition algorithm to be executed, the public key for the requestor, and a threshold value for accepting the facial recognition comparison and approving the transaction.

The method 300 includes searching, by the validator, for a previous transaction in a previous block in the blockchain containing a previously saved facial image (e.g., a second facial) image of the requestor. In one embodiment, the requestor can be either a buyer, a seller, or a third party. Based on the identity of the requestor, the method 300 will access a second facial image previously stored of the requestor. The second facial image at 304 may be stored in a block of the blockchain as described in 212. In another embodiment, 304 may include an indicia pointing to a particular block and/or transaction, mutually agreed to by the parties where the second facial image should be accessed. This provides the requestor a certain level of control as to which previously saved image should be used for facial recognition in regard to a current transaction.

The method 300 includes 306 decrypting, by the validator, the a portion of the previous transaction containing the previously saved facial image of the party (e.g., second facial image) using the public key of the requestor. In another embodiment, the facial images are stored unencrypted rather than encrypted and the processing skips this step.

The method 300 includes 308 retrieving, by the processor, the facial recognition algorithm to executed in comparing the first facial image and second facial image. In one embodiment, genesis block of the blockchain includes the algorithm or other indicia for the algorithm. The genesis block describes the nature of the blockchain and rules for participating in the blockchain. A second embodiment includes the algorithm or an indicia for the algorithm in a smart contract of the blockchain. A third embodiment, a validator stores one or more facial recognition algorithms.

The method 300 includes 310 executing, by the validator, the facial recognition algorithm to determine a percentage of matching characteristics between the previously saved facial image and the presented facial image of the party. Different facial features can be compared. Different facial recognition algorithms may compare different facial features, e.g., skin tone, hair color, eyebrow color, eye color, eye sizes, retina pattern, distance between eyes, lip shape/size, nose shape/size, cheek shape, etc. In one embodiment, different facial recognition algorithms may give different weights to different facial features. For example, one facial recognition algorithm can be generally expressed as Q=w₁f₁+w₂f₂+w₃f₃+ . . . wₙfₙ, wherein Q is a final score; w is a weight factor for the corresponding facial feature; f is the facial feature; n is any positive integer representing numbers of facial features considered in the algorithm. In one embodiment, the various wᵢ are coefficients, wherein the summations of wᵢ is 1, which can be expressed as 1=Σᵢ₌₁ⁿwᵢ. In some embodiments, different facial recognition algorithms may have different combination of facial features and weight factors. Each algorithm may have a first predetermined threshold θ for Q, if Q>θ, then the determination is “pass;” if Q<θ, then the determination is “fail.”

The method 300 includes 310 providing, by the processor, a score to a similarity of the first and second facial images based on the comparison. In one embodiment, the score is the Q mentioned above.

The method 300 includes 312 determining whether the percentage of matching characteristics (e.g., the score Q) exceeds the threshold value. In one embodiment, the threshold is the first predetermined threshold θ mentioned above.

If Q>θ or Q=θ, then the method 300 moves to 314 and the determination is “pass.” The “pass” signal means the facial recognition comparison at 310 shows the first facial image and the second facial image are similar enough. In one embodiment, this means the transaction-in-interest can be approved, as determined by the particular validator. Note, other validators' determination may also be considered before a final decision can be made to approve the transaction-in-interest.

If Q<θ, the method 300 moves to 316 and the determination is “fail.” The “fail” signal means the facial recognition comparison at 310 shows the first facial image and the second facial image are not similar enough. In one embodiment, this means the transaction-in-interest should not be approved, as determined by the particular validator.

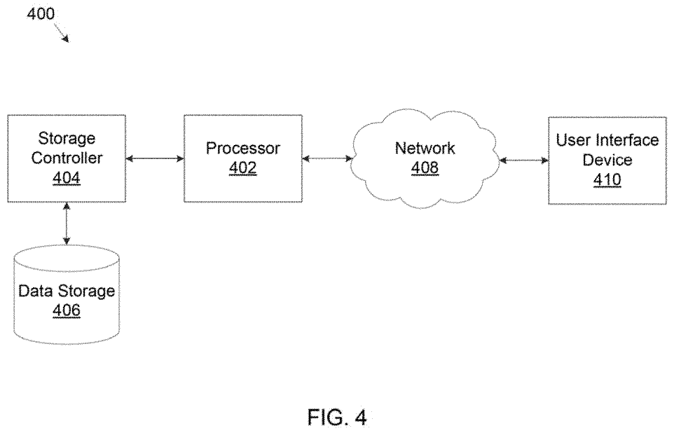

FIG. 4 illustrates a computer network 400 for obtaining access to database files in a computing system according to one embodiment of the disclosure. The processor 402 can be the processor of a participant device 102, a member service server 104, a validator 108, and/or a summary depository 106.

The system 400 may include a processor 402, a data storage device 406, a network 408, and a user interface device 410. The processor 402 may execute a hypervisor-based system executing one or more guest partitions hosting operating systems with modules having server configuration information. In a further embodiment, the system 400 may include a storage controller 404, or a storage server configured to manage data communications between the data storage device 406 and the processor 402 or other components in communication with the network 408. In an alternative embodiment, the storage controller 404 may be coupled to the network 408.

In one embodiment, the user interface device 410 is referred to broadly and is intended to encompass a suitable processor-based device such as a desktop computer, a laptop computer, a personal digital assistant (PDA) or tablet computer, a smartphone or other mobile communication device having access to the network 408. In a further embodiment, the user interface device 410 may access the Internet or other wide area or local area network to access a web application or web service hosted by a server having the processor 402 and may provide a user interface for enabling a user to enter or receive information.

The network 408 may facilitate communications of data between the processor 402 and the user interface device 410. The network 408 may include any type of communications network including, but not limited to, a direct PC-to-PC connection, a local area network (LAN), a wide area network (WAN), a modem-to-modem connection, the Internet, a combination of the above, or any other communications network now known or later developed within the networking arts which permits two or more computers to communicate.

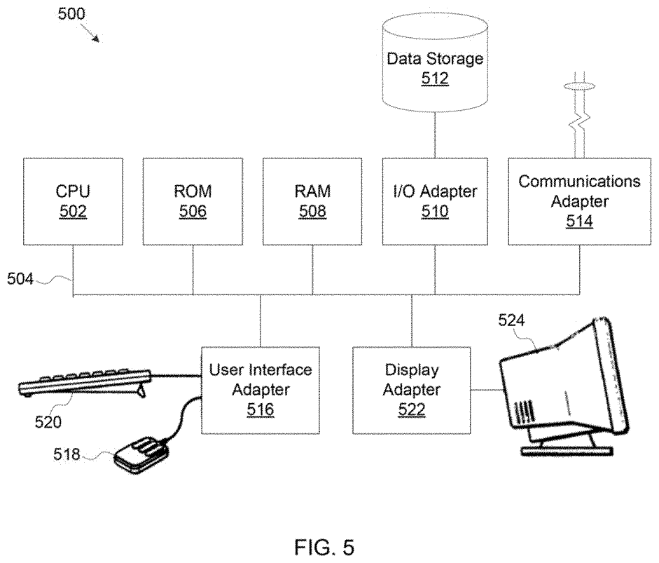

FIG. 5 illustrates a computer system 500 adapted according to certain embodiments of the processor 502 and/or the user interface device 510. The central processing unit (“CPU”) 502 is coupled to the system bus 504. The CPU 502 may be a general purpose CPU or microprocessor, graphics processing unit (“GPU”), and/or microcontroller. The present embodiments are not restricted by the architecture of the CPU 502 so long as the CPU 502, whether directly or indirectly, supports the operations as described herein. The CPU 502 may execute the various logical instructions according to the present embodiments.

The computer system 500 may also include random access memory (RAM) 508, which may be synchronous RAM (SRAM), dynamic RAM (DRAM), synchronous dynamic RAM (SDRAM), or the like. The computer system 500 may utilize RAM 508 to store the various data structures used by a software application. The computer system 500 may also include read only memory (ROM) 506 which may be PROM, EPROM, EEPROM, optical storage, or the like. The ROM may store configuration information for booting the computer system 500. The RAM 508 and the ROM 506 hold user and system data, and both the RAM 508 and the ROM 506 may be randomly accessed.

The computer system 500 may also include an I/O adapter 510, a communications adapter 514, a user interface adapter 516, and a display adapter 522. The I/O adapter 510 and/or the user interface adapter 516 may, in certain embodiments, enable a user to interact with the computer system 500. In a further embodiment, the display adapter 522 may display a graphical user interface (GUI) associated with a software or web-based application on a display device 524, such as a monitor or touch screen.

The I/O adapter 510 may couple one or more storage devices 512, such as one or more of a hard drive, a solid state storage device, a flash drive, a compact disc (CD) drive, a floppy disk drive, and a tape drive, to the computer system 500. According to one embodiment, the data storage 512 may be a separate server coupled to the computer system 500 through a network connection to the I/O adapter 510. The communications adapter 514 may be adapted to couple the computer system 500 to the network 508, which may be one or more of a LAN, WAN, and/or the Internet. The user interface adapter 516 couples user input devices, such as a keyboard 520, a pointing device 518, and/or a touch screen (not shown) to the computer system 500. The display adapter 522 may be driven by the CPU 502 to control the display on the display device 524. Any of the devices 502-522 may be physical and/or logical.

The applications of the present disclosure are not limited to the architecture of computer system 500. Rather the computer system 500 is provided as an example of one type of computing device that may be adapted to perform the functions of the server and/or the user interface device. For example, any suitable processor-based device may be utilized including, without limitation, personal data assistants (PDAs), tablet computers, smartphones, computer game consoles, and multi-processor servers. Moreover, the systems and methods of the present disclosure may be implemented on application specific integrated circuits (ASIC), very large scale integrated (VLSI) circuits, or other circuitry. In fact, persons of ordinary skill in the art may utilize any number of suitable structures capable of executing logical operations according to the described embodiments. For example, the computer system 500 may be virtualized for access by multiple users and/or applications.

If implemented in firmware and/or software, the functions described above may be stored as one or more instructions or code on a computer-readable medium. Examples include non-volatile computer-readable media encoded with a data structure and computer-readable media encoded with a computer program. Computer-readable media includes physical computer storage media. A storage medium may be any available medium that can be accessed by a computer. By way of example, and not limitation, such computer-readable media can comprise RAM, ROM, EEPROM, CD-ROM or other optical disk storage, magnetic disk storage or other magnetic storage devices, or any other medium that can be used to store desired program code in the form of instructions or data structures and that can be accessed by a computer. Disk and disc includes compact discs (CD), laser discs, optical discs, digital versatile discs (DVD), floppy disks and blu-ray discs. Generally, disks reproduce data magnetically, and discs reproduce data optically. Combinations of the above should also be included within the scope of computer-readable media.

In addition to storage on computer-readable medium, instructions and/or data may be provided as signals on transmission media included in a communication apparatus. For example, a communication apparatus may include a transceiver having signals indicative of instructions and data. The instructions and data are configured to cause one or more processors to implement the functions outlined in the claims.

Although the present disclosure and its advantages have been described in detail, it should be understood that various changes, substitutions and alterations can be made herein without departing from the spirit and scope of the disclosure as defined by the appended claims. Moreover, the scope of the present application is not intended to be limited to the particular embodiments of the process, machine, manufacture, composition of matter, means, methods and steps described in the specification. As one of ordinary skill in the art will readily appreciate from the present invention, disclosure, machines, manufacture, compositions of matter, means, methods, or steps, presently existing or later to be developed that perform substantially the same function or achieve substantially the same result as the corresponding embodiments described herein may be utilized according to the present disclosure. Accordingly, the appended claims are intended to include within their scope such processes, machines, manufacture, compositions of matter, means, methods, or steps.

What is claimed is:

1. A computing system architecture, comprising
a service server;
a first validator, the first validator being communicable to the service server; and
a validation request sent from the service server to the first validator for validating a transaction, the validation request including a first facial image of a party of the transaction, the validation request including a public key of the party, wherein the public key of the party decrypts a second facial image of the party, the second facial image is associated with a previously conducted transaction;
wherein the validator performs a facial recognition using the first facial image of the party for validating the transaction.

2. The computing system architecture according to claim 1, wherein the first validator includes a plurality of facial recognition algorithms.

3. The computing system architecture according to claim 2, wherein the first validator uses a process to randomly select one of the plurality of facial recognition algorithms for performing the facial recognition.

4. The computing system architecture according to claim 3, wherein the process uses a time that the validation request received by the first validator as a factor to randomly select one of the plurality of facial recognition algorithms.

5. The computing system architecture according to claim 2, wherein each of the plurality of facial recognition algorithms considers one or more facial features when performing the facial recognition.

6. The computing system architecture according to claim 5, wherein each of the plurality of facial recognition algorithms gives each of the facial features a different weight factor when performing the facial recognition.

7. The computing system architecture according to claim 1, wherein the second facial image of the party is stored in a block of a blockchain.

8. The computing system architecture according to claim 1, wherein the second facial image of the party is encrypted with a private key of the party, separate from the public key of the party.

9. The computing system according to claim 1, a block representing the transaction is created and annexed to a blockchain.

10. The computing system according to claim 9, wherein the service server responds to a single audit request by sending the block to a requestor without having the requestor to send multiple audit requests to access multiple ledgers distributed among multiple servers.

11. A service server, comprising
a processor; and
a machine readable memory accessible to the processor, wherein the machine readable memory includes instructions, when executed, the instructions direct the processor to perform following actions:
receiving a validation request, the validation request including a first facial image of a party of a transaction, the validation request including a public key of the party, wherein the public key of the party decrypts a second facial image of the party, the second facial image is associated with a previously conducted transaction;
distributing the validation request to a plurality of validators; and
receiving a pass or a fail decision of the validation request from each validator, wherein the “pass” decision means the validation request includes valid information for approving the transaction, the “fail” decision does not include valid information for approving the transaction.

12. The service server according to claim 11, the actions further including
determining whether more than a threshold percentage of validators provide the “pass” decision.

13. The service server according to claim 12, the actions further including
validating the transaction by creating a block, if more than the threshold percentage of validators provide the “pass” decision.

14. The service server according to claim 11, the actions further including
creating a block associated with the transaction and incorporating the block into a blockchain.

15. The service server according to claim 14, wherein the block includes at least one information selected from the following: an identity of a party of the transaction, the first facial image, descriptions of goods/services transacted, and identities of the plurality of validators.

16. The service server according to claim 11, the actions further including
retrieving the second facial image;
decrypting the second facial image with the public key of the party, wherein the second facial image is encrypted with a private key, the private key is separate from the public key.

17. The service server according to claim 16, wherein the second facial image is stored in a block previously established in a blockchain.

18. The service server according to claim 11, the actions further including
determining whether two or more facial recognition algorithms are used by the plurality of validators.

19. The service server according to claim 11, wherein at least one of the plurality of validators retrieves a second facial image of the party previously stored.

20. The service server according to claim 11, wherein the at least one of the plurality of validators compares the first facial image and the second facial image to determine a similarity.
